(19) United States
(12) Patent Application Publication
(10) Pub. No.: US 2014/0222236 A1
(43) Pub. Date: Aug. 7, 2014

(54) POWER TRANSMISSION DEVICE, POWER TRANSMISSION SYSTEM, POWER TRANSMISSION METHOD, AND PROGRAM

(71) Applicant: Canon Kabushiki Kaisha, Tokyo (JP)

(72) Inventor: Shozo Yamasaki, Tokyo (JP)

(73) Assignee: Canon Kabushiki Kaisha, Tokyo (JP)

(21) Appl. No.: 14/174,682

(22) Filed: Feb. 6, 2014

(30) Foreign Application Priority Data
Feb. 7, 2013 (JP) 2013-022377

(51) Int. Cl. H02J 7/02

(52) U.S. Cl. CPC H02J 7/025
USPC 700/295

(57) ABSTRACT

A power transmission device includes a power reception notification receiving unit configured to receive from a power receiving device a power reception notification indicating that the power receiving device has received power, a power determination unit configured to determine, if the power reception notification receiving unit has received the power reception notification, a transmission power value for power transmission to the power receiving device as first power, and to determine, if the power reception notification receiving unit does not receive the power reception notification, the transmission power value for power transmission to the power receiving device as second power, which is smaller than the first power, and a power transmission unit configured to wirelessly transmit the power determined by the power determination unit to the power receiving device.

### BACKGROUND OF THE INVENTION

1. Field of the Invention

The present invention relates to a power transmission device, a power transmission system, a power transmission method, and a program.

2. Description of the Related Art

Systems for supplying power in a contactless (wireless) manner are conventionally known. There are four types of wireless power supply systems: an electromagnetic induction system, a magnetic resonance system, an electric field coupling system, and a radio wave receiving system. In recent years, among these four systems, the magnetic resonance system has attracted attention because of its capabilities of transmitting a large amount of power and transmitting power over a long distance. For example, Japanese Patent Application Laid-Open No. 2009-136132 discusses a one-to-N power supply system that utilizes the magnetic resonance system having this long-distance power transmission capability to transmit power from a power transmission device to a plurality of wireless power receiving devices.

In the technique discussed in Japanese Patent Application Laid-Open No. 2009-136132, the power transmission device sends a fixed pulse signal in a standby mode with no power transmission to search for any wireless power receiving device that is located within several meters of the transmission device. The power transmission device determines based on the unique identification number (ID) sent from the power receiving device whether this device is a target wireless power receiving device to be power supplied. Then, the power transmission device sends a power signal to the target power receiving device to be power supplied.

In some cases, however, the communication area in which the power transmission device can send a pulse signal is larger than the power supply area in which the power transmission device can transmit a power signal. In such cases, the power transmission device can search for any wireless power receiving device by sending a pulse signal, but may not be able to transmit power to the wireless power receiving device by transmitting a power signal. With regard to the communication area larger than the power supply area, standards organizations such as International Organization for Standardization (ISO) and International Electrotechnical Commission (IEC) are proceeding to standardize one-to-N wireless power supply standards (see “Telecommunications and Information Exchange Between Systems” ISO/IEC JTC 1/SC 06 N 15027, November 2011, and “Management Protocol of Wireless Power Transfer for Multi-devices” ITC 100, March 2012). According to the standards, after the power transmission device sends a power signal to the wireless power receiving device, the wireless power receiving device sends a notification of power supply status to the power transmission device, so that the power transmission device can determine whether the wireless power receiving device is located within the power supply area.

However, the above-described standards do not mention the power signal level at the time of transmitting the power signal from the power transmission device to the wireless power receiving device. Conventionally, when a wireless power receiving device is located within the communication area of a power transmission device and outside the power supply area thereof, the power transmission device transmits a power signal to the wireless power receiving device even though the wireless power receiving device cannot receive the power. Thus, there has been a problem in that the power transmission device transmits an unnecessary power signal before the wireless power receiving device enters the power supply area.

### SUMMARY OF THE INVENTION

The present invention is directed to suppressing unnecessary power transmission from a power transmission device to a power receiving device during wireless power supply.

According to an aspect of the present invention, a power transmission device includes a power reception notification receiving unit configured to receive from a power receiving device a power reception notification indicating that the power receiving device has received power, a power determination unit configured to determine a transmission power value for power transmission to the power receiving device as first power if the power reception notification receiving unit has received the power reception notification, and to determine the transmission power value for power transmission to the power receiving device as second power, which is smaller than the first power, if the power reception notification receiving unit does not receive the power reception notification, and a power transmission unit configured to wirelessly transmit the power determined by the power determination unit to the power receiving device.

Further features of the present invention will become apparent from the following description of exemplary embodiments with reference to the attached drawings.

### BRIEF DESCRIPTION OF THE DRAWINGS

FIG. 1 is a diagram illustrating a wireless power supply system.

FIG. 2 is a diagram illustrating a power transmission device.

FIG. 3 is a diagram illustrating a power receiving device.

FIG. 4 is a diagram illustrating an example of a superframe.

FIG. 5 is a diagram illustrating an example of a frame format of a packet.

FIG. 6 is a sequence diagram illustrating power supply processing.

FIG. 7 is a flowchart illustrating power transmission processing performed by a power receiving device.

FIG. 8 is a flowchart illustrating power transmission processing performed by a power transmission device.

FIG. 9 is a diagram illustrating a timing of switching the power level of transmission power.

FIG. 10 is a diagram illustrating a timing chart of power transmission.

### DESCRIPTION OF THE EMBODIMENTS

Various exemplary embodiments, features, and aspects of the invention will be described in detail below with reference to the drawings.

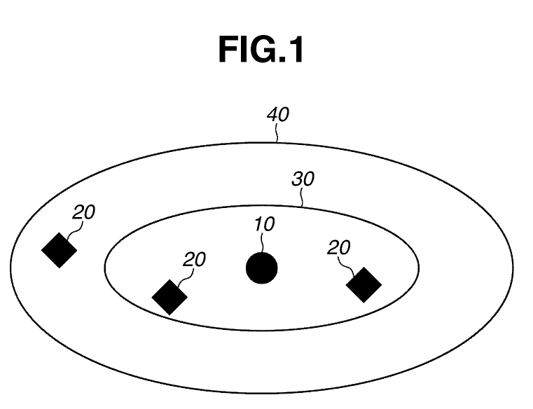

FIG. 1 is a diagram illustrating a wireless power supply system serving as a power transmission system according to an exemplary embodiment of the present invention. The wireless power supply system includes an image forming device 10, which serves as a power transmission device, and power receiving devices 20. The power receiving devices 20 are, for example, mobile terminals such as smartphones and mobile phones. FIG. 1 illustrates three power receiving devices 20. However, the present exemplary embodiment does not restrict the number of the power receiving devices 20.

The power transmission device 10 wirelessly transmits power to the power receiving device 20. Further, the power transmission device 10 performs data communication required for power supply with the power receiving device 20. The power receiving device 20 wirelessly receives power from the power transmission device 10. Further, the power receiving device 20 performs data communication required for power supply with the power transmission device 10.

A power supply area 30 is an area in which power can be supplied from the power transmission device 10 to the power receiving device 20. The power supply area 30 is determined by the power supply capability of the power transmission device 10. As illustrated in FIG. 1, if a plurality of the power receiving devices 20 is located within the power supply area 30, the power transmission device 10 can perform wireless power supply to each of the plurality of power receiving devices 20.

A communication area 40 is an area in which data communication can be performed between the power transmission device 10 and the power receiving device 20. The communication area 40 is larger than the power supply area 30. Thus, the communication area 40 includes the power supply area 30.

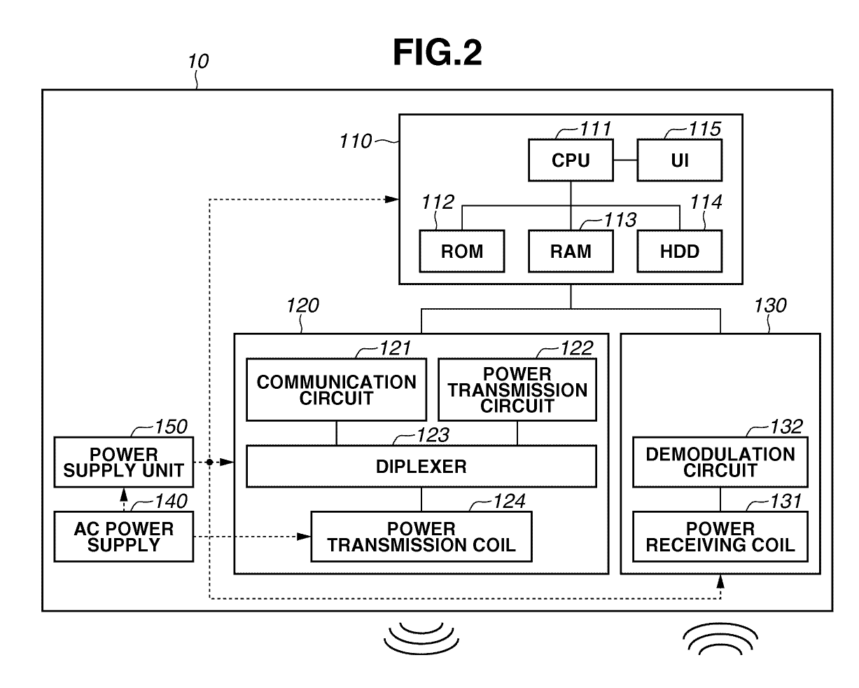

FIG. 2 is a diagram illustrating the power transmission device 10. In FIG. 2, solid lines represent the flow of data and dashed lines represent the flow of power. The power transmission device 10 includes a control unit 110, a wireless transmission unit 120, a wireless reception unit 130, an alternating current (AC) power supply 140, and a power supply unit 150.

The control unit 110 controls the entire power transmission device 10. The control unit 110 includes a central processing unit (CPU) 111, a read only memory (ROM) 112, a random access memory (RAM) 113, a hard disk drive (HDD) 114, and a user interface (UI) 115. The control unit 110 is connected to the wireless transmission unit 120 and the wireless reception unit 130 via an internal bus.

The CPU 111 processes various kinds of data and controls the power transmission device 10. The ROM 112 is a non-volatile storage medium and stores a boot program and the like to be used by the CPU 111. The RAM 113 is a volatile storage medium and temporarily stores data, a program, and the like to be used by the CPU 111. The HDD 114 is a non-volatile storage medium and stores an operating system (OS), an application, and the like to be used by the CPU 111. The UI 115 shows various kinds of information to a user and receives various instructions from the user.

Functions of the power transmission device 10 and processing performed by the power transmission device 10 to be described below are realized by the CPU 111 reading out a program stored in the ROM 112 or the HDD 114 and executing the program.

The wireless transmission unit 120 wirelessly supplies power to the power receiving device 20. The wireless transmission unit 120 includes a communication circuit 121, a power transmission circuit 122, a diplexer 123, and a power transmission coil 124. The communication circuit 121 generates a modulation signal to be used for communication. The power transmission circuit 122 generates a modulation signal to be used for power transmission. The diplexer 123 combines a modulation signal generated by the communication circuit 121 with a modulation signal generated by the power transmission circuit 122. The power transmission coil 124 sends the modulation signal combined by the diplexer 123 to the power receiving device 20.

The wireless reception unit 130 receives data from the power receiving device 20. The wireless reception unit 130 includes a power receiving coil 131 and a demodulation circuit 132. The power receiving coil 131 receives a modulation signal for communication from the power receiving device 20. The demodulation circuit 132 demodulates the modulation signal received by the power receiving coil 131.

The AC power supply 140 supplies an AC voltage to the power transmission coil 124 and the power supply unit 150. The power supply unit 150 converts the AC voltage supplied from the AC power supply 140 into a direct current (DC) voltage, followed by supplying the DC voltage to the control unit 110, the wireless transmission unit 120, and the wireless reception unit 130.

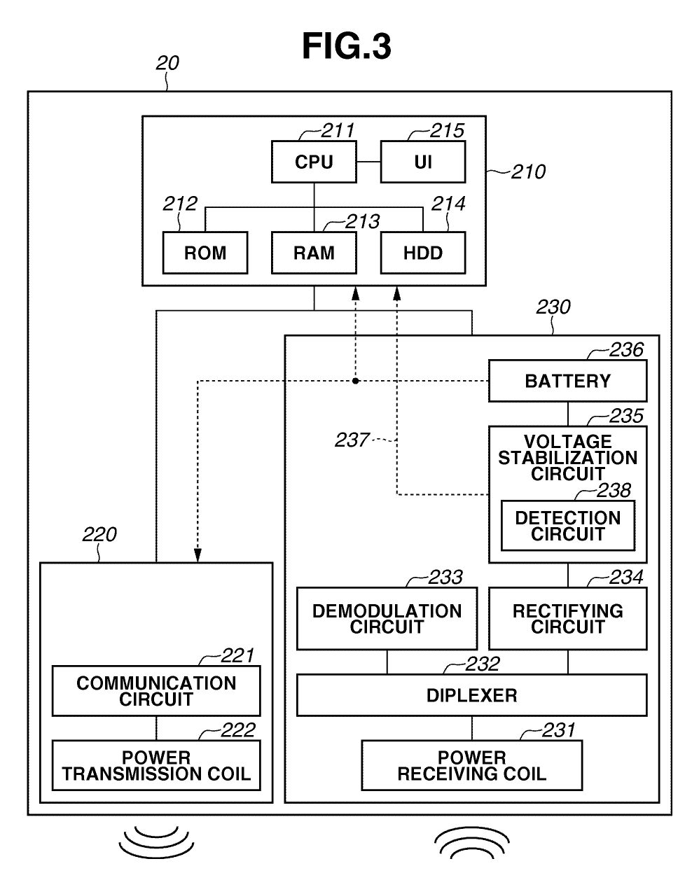

FIG. 3 is a diagram illustrating the power receiving device 20. In FIG. 3, solid lines represent the flow of data and dashed lines represent the flow of power. The power receiving device 20 includes a control unit 210, a wireless transmission unit 220, and a wireless reception unit 230.

The control unit 210 controls the entire power receiving device 20. The control unit 210 includes a CPU 211, a ROM 212, a RAM 213, a HDD 214, and a UI 215. The control unit 210 is connected to the wireless transmission unit 220 and the wireless reception unit 230 via an internal bus.

The CPU 211 processes various kinds of data and controls the power receiving device 20. The ROM 212 is a non-volatile storage medium and stores a boot program and the like to be used by the CPU 211. The RAM 213 is a volatile storage medium and temporarily stores data, a program, and the like to be used by the CPU 211. The HDD 214 is a non-volatile storage medium and stores an operating system (OS), an application, and the like to be used by the CPU 211. The UI 215 shows various kinds of information to a user and receives various instructions from the user.

Functions of the power receiving device 20 and processing performed by the power receiving device 20 to be described below are realized by the CPU 211 reading out a program stored in the ROM 212 or the HDD 214 and executing the program.

The wireless transmission unit 220 wirelessly sends data to the power transmission device 10. The wireless transmission unit 220 includes a communication circuit 221 and a power transmission coil 222. The communication circuit 221 generates a modulation signal to be used for communication. The power transmission coil 222 sends the modulation signal generated by the communication circuit 221 to the power transmission device 10.

The wireless reception unit 230 wirelessly receives power from the power transmission device 10. The wireless reception unit 230 includes a power receiving coil 231, a diplexer 232, a demodulation circuit 233, a rectifying circuit 234, a voltage stabilization circuit 235, and a battery 236. The power receiving coil 231 receives a modulation signal from the power transmission device 10. The diplexer 232 splits the modulation signal received by the power receiving coil 231 into a modulation signal for communication and a modulation signal for power transmission. The demodulation circuit 233 demodulates the modulation signal for communication output from the diplexer 232. The rectifying circuit 234 rectifies the modulation signal for power transmission output from the diplexer 232 to generate a DC voltage. The voltage stabilization circuit 235 stabilizes the DC voltage generated by the rectifying circuit 234.

The battery 236 receives the voltage stabilized by the voltage stabilization circuit 235, and then accumulates power. Further, based on the accumulated voltage, the battery 236 supplies a DC voltage to the control unit 210, the wireless transmission unit 220, and the wireless reception unit 230. The voltage stabilization circuit 235 includes a detection circuit 238 that detects a DC voltage input from the rectifying circuit 234. The voltage stabilization circuit 235 sends an output signal from the detection circuit 238 as a DC voltage detection signal 237 to the control unit 210. The wireless reception unit 230 receives power when the power receiving device 20 is located inside the power supply area 30. The wireless reception unit 230 does not receive power when the power receiving device 20 is located outside the power supply area 30. The control unit 210 monitors a change in the detection signal 237 to detect whether the power receiving device 20 is located inside the power supply area 30.

In the present exemplary embodiment, the wireless reception unit 230 is configured to detect whether power is received from the power transmission device 10. However, the present exemplary embodiment does not restrict the processing for detecting power reception. Alternatively, for example, a circuit other than the voltage stabilization circuit 235 may include the detection circuit 238. In addition, as another example, the detection circuit 238 may detect power reception based on a change in the current received from the power transmission device 10 or a change in the charge capacity of the battery 236.

Further, in the present exemplary embodiment, data communication is performed between the power receiving device 20 and the power transmission device 10 via the wireless transmission unit 120, the wireless reception unit 130, the wireless transmission unit 220, and the wireless reception unit 230. However, the data communication method is not limited thereto. Alternatively, the power receiving device 20 and the power transmission device 10 may include their respective wireless communication units and employ these units to perform data communication between the power receiving device 20 and the power transmission device 10.

Here, the wireless communication unit is a control circuit for performing network communication with an external device, which is compatible with the wireless standards such as Wi-Fi (registered trademark) and Bluetooth (registered trademark). It is assumed that a distance within which communication can be performed by the wireless communication unit is larger than the communication area 40 covered by the wireless transmission unit 120, the wireless reception unit 130, the wireless reception unit 230, and the wireless transmission unit 220. However, the wireless communication unit is not restricted by the communication distance.

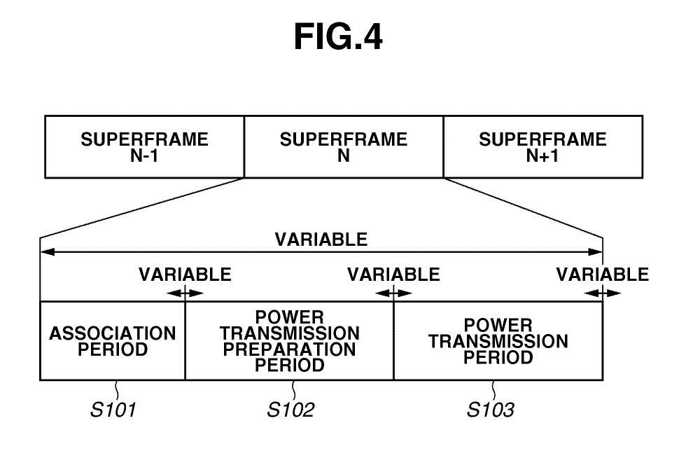

FIG. 4 is a diagram illustrating an example of a structure of a superframe. The wireless power supply system according to the present exemplary embodiment uses a superframe as illustrated in FIG. 4 as one unit and repeatedly uses the superframe, so that power can be transmitted from the power transmission device 10 to the power receiving device 20. One superframe includes step S101 (association period), step S102 (power transmission preparation period), and step S103 (power transmission period), and each of the periods is variable.

In step S101, the power transmission device 10 checks the necessity for the power receiving device 20 to receive power. If the power receiving device 20 request power transmission, the proceeding proceeds to step S102. The transition period from step S101 to step S102 is also variable.

In step S102, the power receiving device 20 can send a response frame or an acknowledgement frame in response to data request from the power transmission device 10. The respective lengths of the response frame and the acknowledgement frame are variable. When the processing in step S102 is completed, then the processing proceeds to step S103. The transition period from step S102 to step S103 is also variable.

In step S103, the power transmission device 10 sends power to the power receiving device 20. In step S103, the power receiving device 20 can send a frame to the power transmission device 10 even if the power receiving device does not receive a request frame from the power transmission device 10.

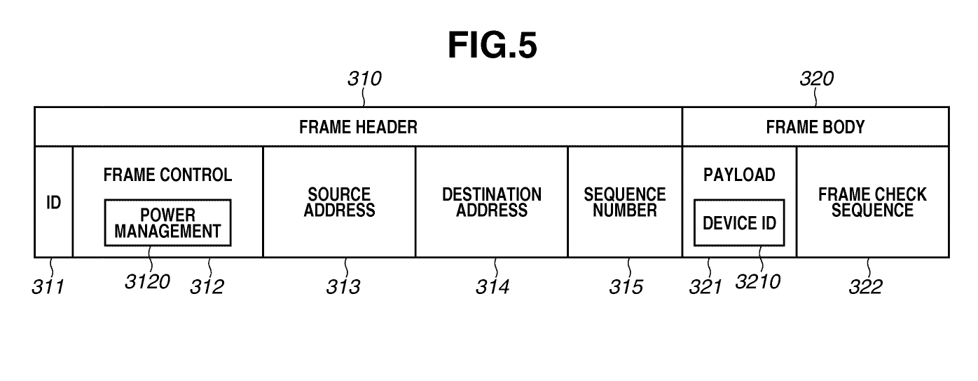

FIG. 5 is a diagram illustrating an example of a structure of a frame format of a packet. The wireless power supply system uses the packet illustrated in FIG. 5 within the superframe to perform data communication for wireless power supply. The packet includes a frame header 310 and a frame body 320.

The frame header 310 indicates an address for data transfer and the like. The frame header 310 includes an ID 311, a frame control 312, a source address 313, a destination address 314, and a sequence number 315. The ID 311 is an ID to be used when the wireless power supply system performs data communication.

The frame control 312 is information for data exchange of the power receiving device 20. The frame control 312 includes a power management 3120. The power management 3120 is the data for checking the necessity for the power receiving device 20 to receive power, i.e., the data indicating whether the power receiving device 20 requests power transmission. The source address 313 is the address of a source for data transfer. The destination address 314 is the address of a destination for data transfer. The sequence number 315 is the number of a frame.

The frame body 320 is data body information for data transfer. The frame body 320 includes a payload 321 and a frame check sequence 322. The payload 321 is the body of data. For example, a device ID 3210 is assigned to the payload 321. The frame check sequence 322 is the data for checking the payload 321 for errors.

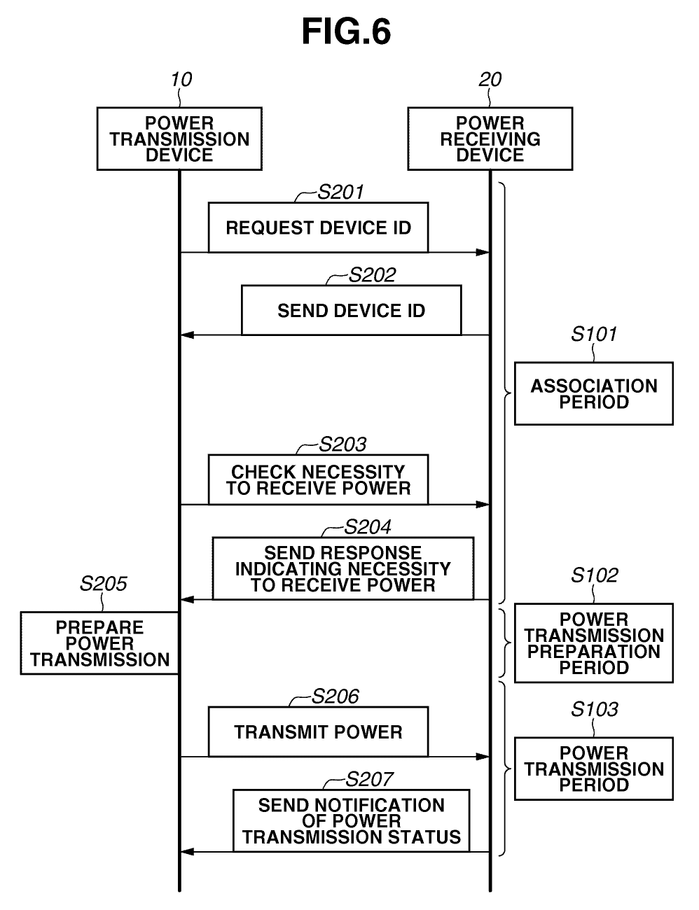

FIG. 6 is a sequence diagram illustrating power supply processing performed by the wireless power supply system. In the power supply processing, the superframe is used to perform data transmission/reception between the power transmission device 10 and the power receiving device 20.

In step S201, the power transmission device 10 requests the power receiving device 20 to send a device ID. For the request, the ID 311 in the frame format illustrated in FIG. 5 is used. In step S202, as a response to the request, the power transmission device 10 receives the device ID from the power receiving device 20. For the response, the device ID 3210 in the frame format illustrated in FIG. 5 is used.

Next, in step S203, the power transmission device 10 checks the necessity for the power receiving device 20 to receive power. For the check, the power management 3120 in the frame format illustrated in FIG. 5 is used. Subsequently, in step S204, if the power receiving device 20 requests power transmission, the power receiving device 20 sends a notification of request for power transmission to the power transmission device 10. If the power receiving device 20 does not request power transmission, the power receiving device 20 sends to the power transmission device 10 a notification that power transmission is not necessary. For the notification, the power management 3120 in the frame format illustrated in FIG. 5 is used.

In step S205, the power transmission device 10 prepares for power transmission. In step S206, the power transmission device 10 transmits power to the power receiving device 20. In step S207, after the power transmission in step S206, the power receiving device 20 sends a notification of power transmission status to the power transmission device 10 as appropriate. Note that after the power transmission in step S206, the power receiving device 20 can send information to the power transmission device 10 even if the power receiving device does not receive a request frame from the power transmission device 10.

In the wireless power supply system according to the present exemplary embodiment, in step S207, when the power receiving device 20 has detected the start of power transmission from the power transmission device 10, the power receiving device 20 sends a notification of start of power transmission to the power transmission device 10. Further, after detecting the start of power transmission, the power receiving device 20 periodically sends to the power transmission device 10 a power reception notification indicating that the power receiving device 20 is in a state of receiving power while the power transmission device continues to transmit power. Furthermore, if the power receiving device 20 has detected that the battery 236 is fully charged, the power receiving device 20 sends a notification of completion of power transmission to the power transmission device 10. In step S207, the power management 3120 in the frame format illustrated in FIG. 5 is used.

Although the details will be described below, the power transmission device 10 according to the present exemplary embodiment changes the power level for power transmission to the power receiving device 20, depending on the notification of power transmission status from the power receiving device 20 in step S207.

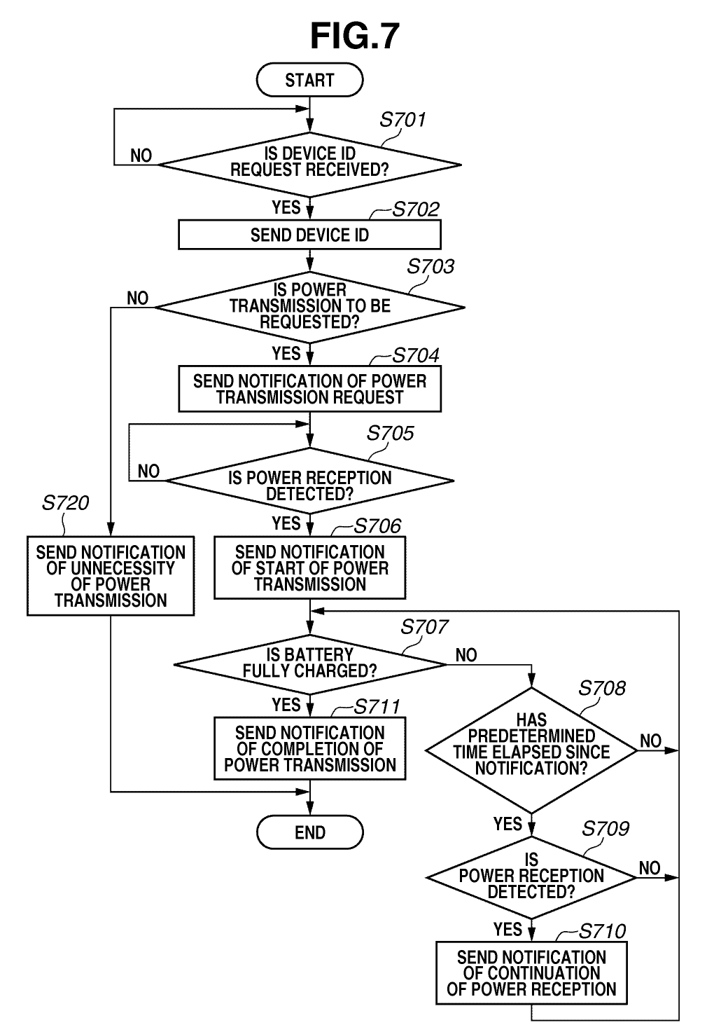

FIG. 7 is flowchart illustrating power transmission processing performed by the power receiving device 20 in the power transmission period. In step S701, the CPU 211 receives a device ID request from the power transmission device 10 via the wireless reception unit 230. If the CPU 211 receives the device ID request from the power transmission device 10 (YES in step S701), then in step S702, the CPU 211 sends the device ID of the power receiving device 20 to the power transmission device 10 via the wireless transmission unit 220.

Next, if the CPU 211 requests power transmission (YES in step S703), then in step S704, the CPU 211 sends a notification of request for power transmission to the power transmission device 10 via the wireless transmission unit 220. On the other hand, if the CPU 211 does not request power transmission (No in step S703), then in step S720, the CPU 211 sends to the power transmission device 10 via the wireless transmission unit 220 a notification that power transmission is not necessary, and the processing is ended.

In step S705, based on the detection signal 237 from the wireless reception unit 230, the CPU 211 detects whether the power receiving device 20 receives power from the power transmission device 10. In step S705, if the CPU 211 does not detect power reception from the power transmission device 10 (NO in step S705), the CPU 211 periodically repeats the processing in step S705. If the CPU 211 detects power reception (YES in step S705), then in step S706, the CPU 211 sends a notification of start of power transmission to the power transmission device 10 via the wireless transmission unit 220. The notification of start of power transmission is an example of a power reception notification indicating that the power receiving device 20 has received power from the power transmission device 10. In addition, the processing in step S706 is an example of processing for sending a power reception notification.

For example, if the power receiving device 20 is located within the power supply area 30, the power receiving device 20 can receive power supplied from the power transmission device 10. In this case, in step S705, the CPU 211 can detect power reception. On the other hand, if the power receiving device 20 is located outside the power supply area 30, the power receiving device 20 cannot receive power supplied from the power transmission device 10. In this case, in step S705, the CPU 211 cannot detect power reception.

In step S707, the CPU 211 checks the remaining amount of the battery 236. If the CPU 211 determines that the battery 236 is not fully charged (NO in step S707), the processing proceeds to step S708. In step S708, the CPU 21 determines whether a predetermined time has elapsed since the last notification. Here, it is assumed that the predetermined time is previously set in the power receiving device 20. In addition, the last notification is either the notification of start of power transmission in step S706 or a notification of continuation of power reception in step S710 to be described below.

If the predetermined time has elapsed (YES in step S708), then in step S709, the CPU 211 detects whether power is received from the power transmission device 10. If the CPU 211 detects power reception (YES in step S709), the CPU 211 advances the processing to step S710. In step S710, the CPU 211 sends a notification of continuation of power reception to the power transmission device 10 via the wireless transmission unit 220. Here, the notification of continuation of power reception is information notifying the power transmission device 10 that the power receiving device 20 continues to receive power and is an example of a power reception notification. Further, the processing in step S710 is an example of processing for sending a power reception notification.

The power receiving device 20 may move to outside the power supply area 30 after the processing in step S705 even though the power receiving device 20 has been located within the power supply area 30 in step S705. In this case, although the power transmission device 10 is supplying power to the power receiving device 20, the power receiving device 20 becomes unable to receive power from the power transmission device 10.

Thus, in the wireless power supply system according to the present exemplary embodiment, the power receiving device 20 performs the processing in steps S708 to S710 to periodically send a notification of continuation of power reception to the power transmission device 10, so that the power transmission device 10 can confirm that the power receiving device 20 continues to receive power.

If the predetermined time has not elapsed since the last notification (NO in step S708) or if power reception is not detected (NO in step S709), the CPU 211 returns the processing to step S707. If the CPU 211 detects that battery 236 is fully charged (YES in step S707), then in step S711, the CPU 211 sends a notification of completion of power transmission to the power transmission device 10 via the wireless transmission unit 220, and the power transmission processing is ended.

As described above, when the power receiving device 20 has detected that power is received from the power transmission device 10, the power receiving device 20 can notify the power transmission device 10 of receiving power.

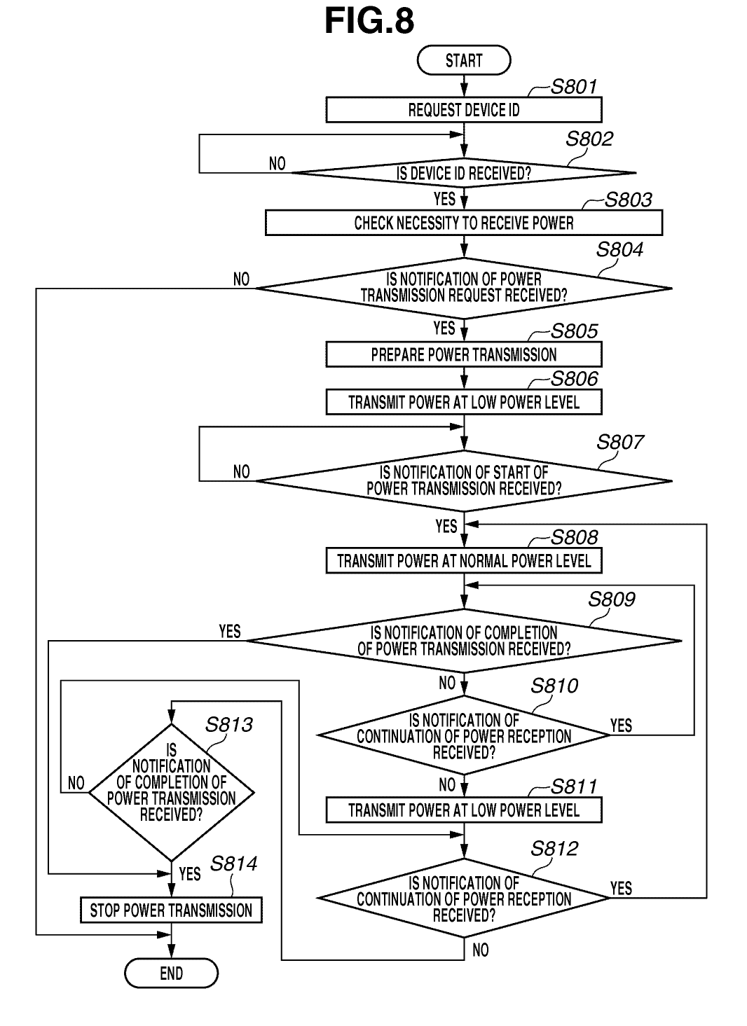

FIG. 8 is a flowchart illustrating power transmission processing by the power transmission device 10 during the power transmission period. In step S801, the CPU 111 sends a device ID request to the power receiving device 20 via the wireless transmission unit 120. If the CPU 111 receives the device ID from the power receiving device 20 via the wireless reception unit 130 (YES in step S802), then in step S803, the CPU 111 checks via the wireless transmission unit 120 whether the power receiving device 20 needs to receive power.

In step S804, if the CPU 111 receives from the power receiving device 20 via the wireless reception unit 130 a notification of request for power transmission indicating that the power receiving device 20 requests power transmission (YES in step S804), then in step S805, the CPU 111 prepares for power transmission. In step S804, if the CPU 111 receives from the power receiving device 20 a notification that power transmission is not necessary (NO in step S804), the CPU 111 ends the power transmission processing.

In step S806, the CPU 111 determines the power value for power transmission from the wireless transmission unit 120 as a low power level, or the second power (power determination processing). Then, the CPU 111 controls power transmission from the wireless transmission unit 120 at the low power level (power transmission control processing). At this time, the wireless transmission unit 120 performs power transmission under control of the CPU 111 (power transmission processing).

In step S807, if the CPU 111 receives a notification of start of power transmission from the power receiving device 20 via the wireless reception unit 130 (YES in step S807), the CPU 111 advances the processing to step S808. The notification of start of power transmission is an example of a power reception notification. The processing for receiving the notification of start of power transmission in step S807 is an example of processing for receiving a power reception notification.

In step S808, the CPU 111 determines the power value for power transmission from the wireless transmission unit 120 as a normal power level, which is the first power higher than the low power level or the second power (power determination processing). Then, the CPU 111 controls power transmission from the wireless transmission unit 120 at the normal power level (power transmission control processing) and the wireless transmission unit 120 performs power transmission (power transmission processing).

The power transmission device 10 can receive a notification of start of power transmission from the power receiving device 20 only in the case that the power receiving device 20 is located within the power supply area 30. The power transmission device 10 continues to supply power at the low power level until the power transmission device 10 determines by the above-described processing that the power receiving device 20 is located within the power supply area 30. This can suppress unnecessary power transmission from the power transmission device 10 to the power receiving device 20 while the power receiving device 20 cannot receive power.

Further, the power transmission device 10 previously sets the values for the low and normal power levels. The lower the value for the low power level is, the greater the effect of suppressing unnecessary power transmission is. However, if the value for the low power level is too low, the power receiving device 20 cannot detect power reception. Thus, it is desirable to set the value for the low power level to a value that allows the detection circuit 238 of the power receiving device 20 to detect power reception.

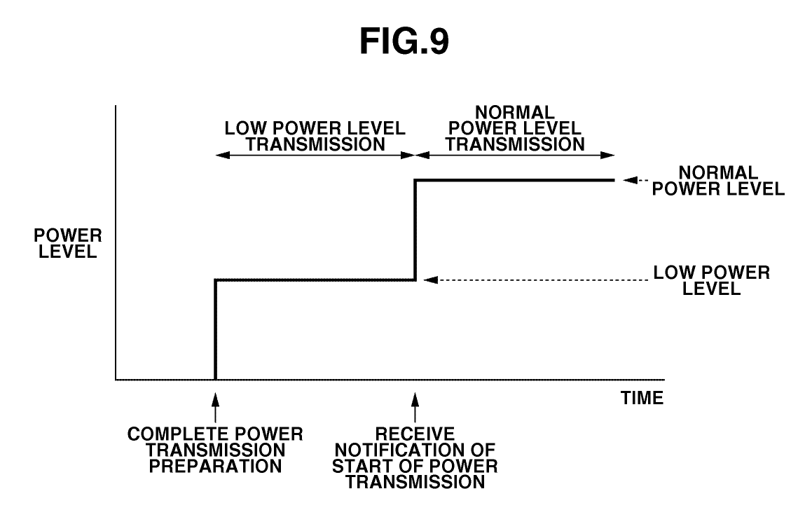

FIG. 9 is a diagram illustrating the timing of switching the power level of transmission power (transmission power setting value), which is performed by the power transmission device 10. In FIG. 9, the horizontal axis represents a time and the vertical axis represents a power level of transmission power. As illustrated in FIG. 9, the CPU 111 of the power transmission device 10 starts power transmission at the low power level when the power transmission preparation period has completed. Then, when the CPU 111 has received a notification of start of power transmission, the CPU 111 switches the transmission power setting value from the low power level to the normal power level, thereby starting power transmission at the normal power level.

Returning to FIG. 8, in step S809, if the CPU 111 receives a notification of completion of power transmission from the power receiving device 20 via the wireless reception unit 130 (YES in step S809), then in step S814, the CPU 111 stops power transmission from the wireless transmission unit 120 to the power receiving device 20.

On the other hand, in step S809, if the CPU 111 does not receive the notification of completion of power transmission (NO in step S809), the proceeding proceeds to step S810. In step S810, the CPU 111 checks whether the notification of continuation of power transmission is received within a predetermined time after reception of the last notification. Here, the predetermined time is previously set in the power transmission device 10. It is desirable to determine the predetermined time based on the predetermined time in the power receiving device 20 that is considered in step S708 illustrated in FIG. 7. In addition, the last notification is a notification of continuation of power reception that is checked in step S810.

In step S810, if the CPU 111 receives the notification of continuation of power reception within the predetermined time after reception of the last notification (YES in step S810), the CPU 111 returns the processing to step S809. Then, the power transmission device 10 continues to transmit power until receiving the notification of completion of power transmission. In step S810, if the CPU 111 does not receive the notification of continuation of power reception within the predetermined time after reception of the last notification (NO in step S810), the CPU 111 advances the processing to step 811. In step S811, the CPU 111 switches the transmission power value for power transmission from the wireless transmission unit 120 from the normal power level to the low power level.

As described above, the CPU 111 changes the transmission power value to the low power level if the CPU 111 does not receive the notification of continuation of power reception within the predetermined time during power transmission at the normal power level. Then, the wireless transmission unit 120 transmits power at the low power level.

Next, in step S812, if the CPU 111 has received the notification of continuation of power reception (YES in step S812), the processing returns to step S808. If the CPU 111 does not receive the notification of continuation of power reception (NO in step S812), the processing proceeds to step S813. If the CPU 111 receives a notification of completion of power transmission (YES in step S813), the processing proceeds to step S814. On the other hand, if the CPU 111 does not receive the notification of completion of power transmission (NO in step S813), the processing returns to step S812.

As described above, the power transmission device 10 periodically receives a notification of continuation of power reception even after starting power transmission to the power receiving device 20. This allows the power transmission device 10 to detect that the power receiving device 20 moves outside the power supply area 30 if the power transmission device 10 does not receive the notification of continuation of power reception. In this case, the power transmission device 10 changes the power value for power transmission to the power receiving device 20 to a lower value, so that unnecessary power transmission can be suppressed.

As described above, the power transmission device 10 according to the present exemplary embodiment performs power transmission at the normal power level if the power receiving device 20 is located within the power supply area 30. On the other hand, the power transmission device 10 performs power transmission at the low power level if the power receiving device 20 is located outside the power supply area 30. This allows the wireless power supply system to suppress unnecessary power transmission from the power transmission device 10 to the power receiving device 20 during the wireless power supply.

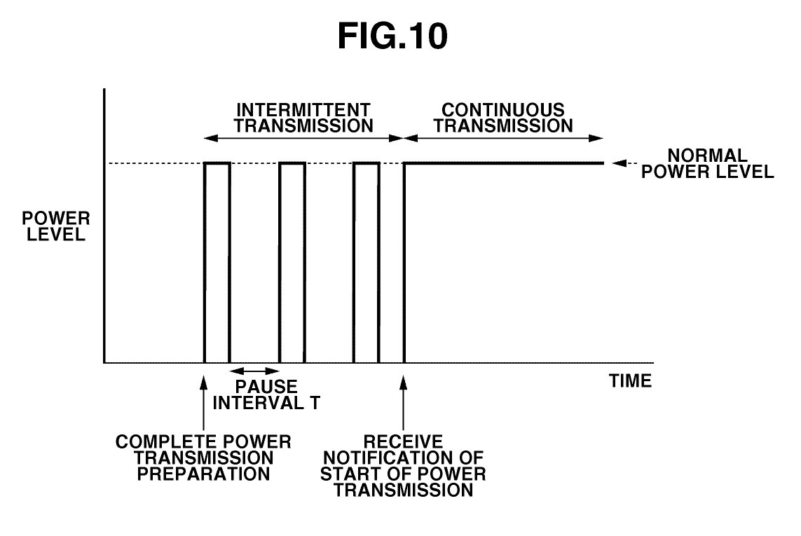

Next, a first modification example of the wireless power supply system will be described. FIG. 10 is a diagram illustrating a timing chart of power transmission of the power transmission device 10 according to the first modification example. In the wireless power supply system according to the present exemplary embodiment, the wireless transmission unit 120 of the power transmission device 10 transmits power at the low power level to the power receiving device 20 located outside the power supply area 30. However, the power transmission method is not limited thereto. Alternatively, for example, the wireless transmission unit 120 may intermittently transmit power at the normal power level to the power receiving device 20 located outside the power supply area 30.

Specifically, in step S806, the CPU 111 determines the power value for power transmission from the wireless transmission unit 120 as the normal power level. Then, the CPU 111 stops power transmission during a pause interval T to cause the wireless transmission unit 120 to transmit power intermittently at predetermined intervals (power transmission control processing). Here, the pause interval T is previously set in the power transmission device 10.

As illustrated in FIG. 10, when the CPU 111 of the power transmission device 10 completes the preparation of power transmission, the CPU 111 starts intermittent transmission at the normal power level. Then, when the CPU 111 has received a notification of start of power transmission, the CPU 111 starts continuous transmission for continuous power supply at the normal power level.

As described above, the power transmission device 10 according to the first modification example reduces the power transmission time by performing intermittent power transmission while the power receiving device 20 is located outside the power supply area 30. This allows the wireless power supply system according to the first modification example to suppress unnecessary power transmission while maintaining the normal power level.

Further, in the first modification example, the longer the pause interval T is, the greater the effect of suppressing unnecessary power transmission is. However, as the pause interval T increases, the time lag between the timing of when the power receiving device 20 moves into the power supply area 30 and the timing of when the power transmission device 10 receives a notification of start of power transmission also increases. Thus, it is desirable to set the pause interval T so that the power transmission device 10 can perform continuous power transmission immediately after detecting the movement of the power receiving device 20 into the power supply area 30.

Next, a second modification example will be described. In the wireless power supply system according to the present exemplary embodiment, after the power transmission device 10 has received a request for power transmission from the power receiving device 20, the power transmission device 10 continues power transmission at the low power level until the power transmission device 10 has received a notification of start of power transmission (steps S806 and S807 in FIG. 8). Thus, the power transmission device 10 cannot transmit power to another power receiving device 20 until the power receiving device 20 moves into the power supply area 30.

On the other hand, in a wireless power supply system according to the second modification example, the power transmission device 10 may set a time threshold for the time period of continuous power transmission at the low power level in steps S806 and S811. Here, the time threshold is previously set in the power transmission device 10.

In this case, when the CPU 111 of the power transmission device 10 has started power transmission at the low power level, the CPU 111 counts the time of power transmission at the low power level. When the power transmission time has reached the time threshold, the CPU 111 instructs the wireless transmission unit 120 to stop power transmission to the power receiving device 20.

Thus, in the wireless power supply system according to the second modification example, when the time period during which the power transmission device 10 performs power transmission at the low power level has reached the time threshold, the power transmission device 10 stops power transmission to the power receiving device 20. Therefore, the power transmission device 10 becomes able to transmit power to another power receiving device 20.

Further, when the power transmission device 10 has stopped power transmission to the power receiving device 20, the power transmission device 10 notifies the power receiving device 20 that power transmission has been stopped. Upon receiving the notification, the power receiving device 20 stops the power transmission processing in FIG. 7. Thus, the power receiving device 20 can restart the power transmission processing in FIG. 7.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-022377 filed Feb. 7, 2013, which is hereby incorporated by reference herein in its entirety.

What is claimed is:

1. A power transmission device comprising:
a power reception notification receiving unit configured to receive from a power receiving device a power reception notification indicating that the power receiving device has received power;
a power determination unit configured to determine, if the power reception notification receiving unit has received the power reception notification, a transmission power value for power transmission to the power receiving device as first power, and to determine, if the power reception notification receiving unit does not receive the power reception notification, the transmission power value for power transmission to the power receiving device as second power, which is smaller than the first power; and
a power transmission unit configured to wirelessly transmit the power determined by the power determination unit to the power receiving device.

2. The power transmission device according to claim 1, further comprising a power transmission control unit configured to cause the power transmission unit to continuously transmit the first power if the transmission power value is determined as the first power, and to cause the power transmission unit to transmit the second power by transmitting the first power intermittently at predetermined intervals if the transmission power value is determined as the second power.

3. The power transmission device according to claim 2, wherein the power transmission control unit causes the power transmission unit to stop power transmission to the power receiving device if a power transmission period during which the power transmission unit continues to transmit the second power has reached a time threshold.

4. The power transmission device according to claim 1, wherein the power reception notification receiving unit periodically receives the power reception notification from the power receiving device, and
wherein the power determination unit changes the transmission power value to the second power if the power reception notification receiving unit does not receive the power reception notification for a predetermined time while the power transmission unit is transmitting the first power.

5. A power transmission system including a power transmission device for wirelessly supplying power and a power receiving device for receiving power from the power transmission device,
wherein the power receiving device comprises:
a power receiving unit configured to receive power from the power transmission device; and
a power reception notification transmitting unit configured to transmit a power reception notification to the power transmission device if the power receiving device has received power, and
wherein the power transmission device comprises:
a power reception notification receiving unit configured to receive the power reception notification from the power receiving device;
a power determination unit configured to determine, if the power reception notification receiving unit has received the power reception notification, a transmission power value for power transmission to the power receiving device as first power, and to determine, if the power reception notification receiving unit does not receive the power reception notification, the transmission power value for power transmission to the power receiving device as second power, which is smaller than the first power; and
a power transmission unit configured to wirelessly transmit the power determined by the power determination unit to the power receiving device.

6. A power transmission method that is executed by a power transmission device, the power transmission method comprising:
receiving from a power receiving device a power reception notification indicating that the power receiving device has received power;
determining, when having received the power reception notification, a transmission power value for power transmission to the power receiving device as first power, and determining, when not receiving the power reception notification, the transmission power value for power transmission to the power receiving device as second power, which is smaller than the first power; and
wirelessly transmitting the determined power to the power receiving device.

7. A power transmission method that is executed by a power transmission system including a power transmission device for wirelessly supplying power and a power receiving device for receiving power from the power transmission device, the power transmission method comprising:
causing the power receiving device to receive power from the power transmission device;
causing the power receiving device to transmit a power reception notification to the power transmission device if the power receiving device has received power;
causing the power transmission device to receive the power reception notification from the power receiving device;
causing the power transmission device to determine, when having received the power reception notification, a transmission power value for power transmission to the power receiving device as first power, and to determine, when not receiving the power reception notification, the transmission power value for power transmission to the power receiving device as second power, which is smaller than the first power; and
causing the power transmission device to wirelessly transmit the determined power to the power receiving device.

8. A computer-readable storage medium storing a program that causes a computer to execute a method comprising:
receiving from a power receiving device a power reception notification indicating that the power receiving device has received power; and
determining, when having received the power reception notification, a transmission power value for power transmission to the power receiving device as first power, and determining, when not receiving the power reception notification, the transmission power value for power transmission to the power receiving device as second power, which is smaller than the first power.
